(19) United States
(12) Patent Application Publication
(10) Pub. No.: US 2009/0098326 A1
(43) Pub. Date: Apr. 16, 2009

(54) Do-it-yourself relief board

(76) Inventor: Ching-Yuan Chang, Sinjhuang City (TW)

Correspondence Address: PRO-TECHTOR INTERNATIONAL SERVICES, 20775 NORADA CT., SARATOGA, CA, 95070, US

(21) Appl. No.: 11/974,365

(22) Filed: Oct. 13, 2007

(51) Int. Cl. B44F 3/00

(52) U.S. Cl. 428/38

(57) ABSTRACT

A do-it-yourself relief board is a transparent plastic relief board, on which is concaved with all kinds of shrinkage pools of patterns or texts, and projected parts on a surface of which are printed with a dark color, allowing the shrinkage pools of the relief board to be light permeable. A piece of relief paper is put on the relief board, and faces toward a light zone, then all kinds of relief patterns can be engraved on the shrinkage pools with a relief pen.

### BACKGROUND OF THE INVENTION

a) Field of the Invention

The present invention relates to a do-it-yourself relief board, and more particularly to a transparent plastic relief board, on which is concaved with all kinds of shrinkage pools of patterns, and on a surface of which is printed with a dark color, such that only the shrinkage pools of patterns on the relief board are light permeable, and projected parts are light non-permeable. When the relief board is put on a light box or a glass board, and a piece of paper is put on the relief board, all kinds of patterns or figures can be engraved on the paper by using a relief pen.

b) Description of the Prior Art

Referring to FIG. 1, a conventional relief board 100 is a metallic board on which is dug out with all kinds of hollow holes 101 of patterns to form light permeable holes. Referring to FIG. 2, the relief board 100 is put on a light box or a bright glass board of window, and then a piece of paper 200 is put on the relief board 100. Next, a relief pen 300 is used to engrave on the paper 200, forming all kinds of patterns or texts along light permeable parts of the hollow holes 101. The conventional relief board 100 is provided with a few shortcomings:
1. The relief board 100, being limited by the hollow holes 101, can be only dug out with continuous holes, and it is impossible to dig out more holes inside the holes. Therefore, the patterns or texts created by the relief board 100 will be limited.
2. The metallic relief board 100 is provided with a higher cost, and it will take more time and manpower to dig out the holes.
3. Fingers will be easily cut by the metallic relief board 100.

### SUMMARY OF THE INVENTION

The primary object of the present invention is to provide a transparent plastic relief board which does not need to be dug out with holes. All kinds of patterns or texts are only required to be concaved on the board, and next a surface of the relief board is printed with a dark color, to accomplish shaping. When a piece of paper is put on the relief board and is put on a light zone, all kinds of patterns or texts can be engraved on the paper with a relief pen. As the light permeable patterns are concaved on the relief board, interiors of shrinkage pools can be concaved again with all kinds of embossed objects, to manufacture all kinds of patterns.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional product.

FIG. 2 shows a schematic view of an embodiment of a conventional product.

FIG. 3 shows a perspective view of the present invention.

FIG. 4 shows a schematic view of an embodiment of the present invention.

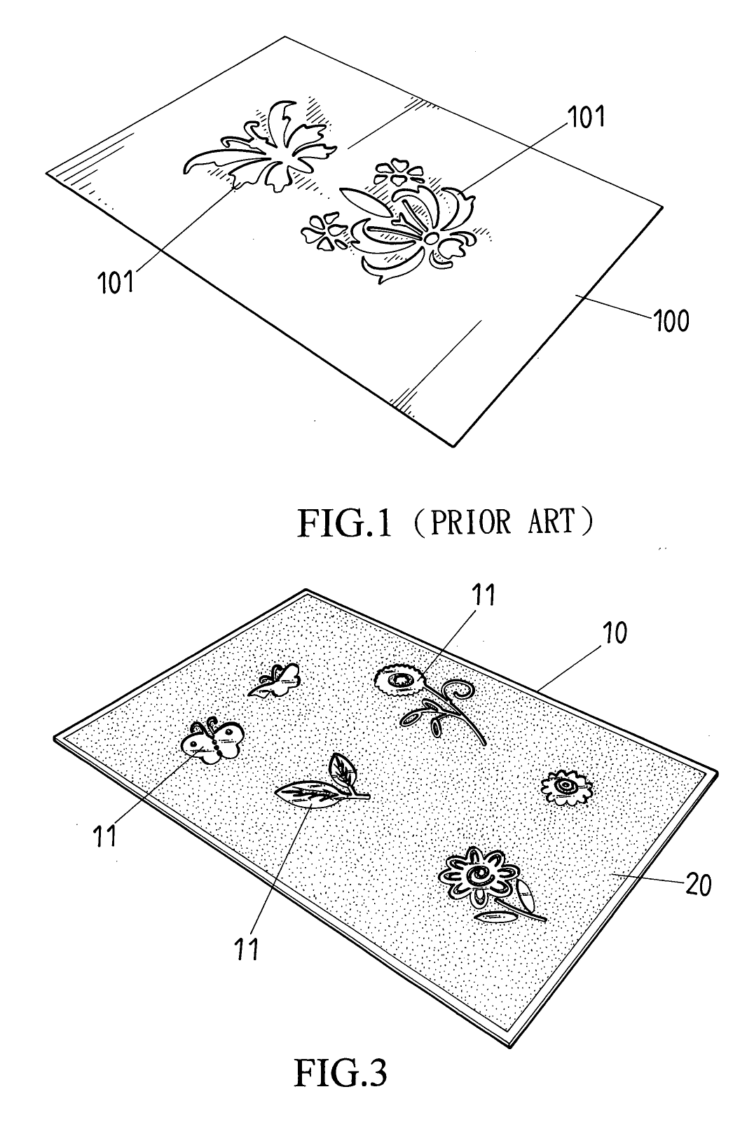

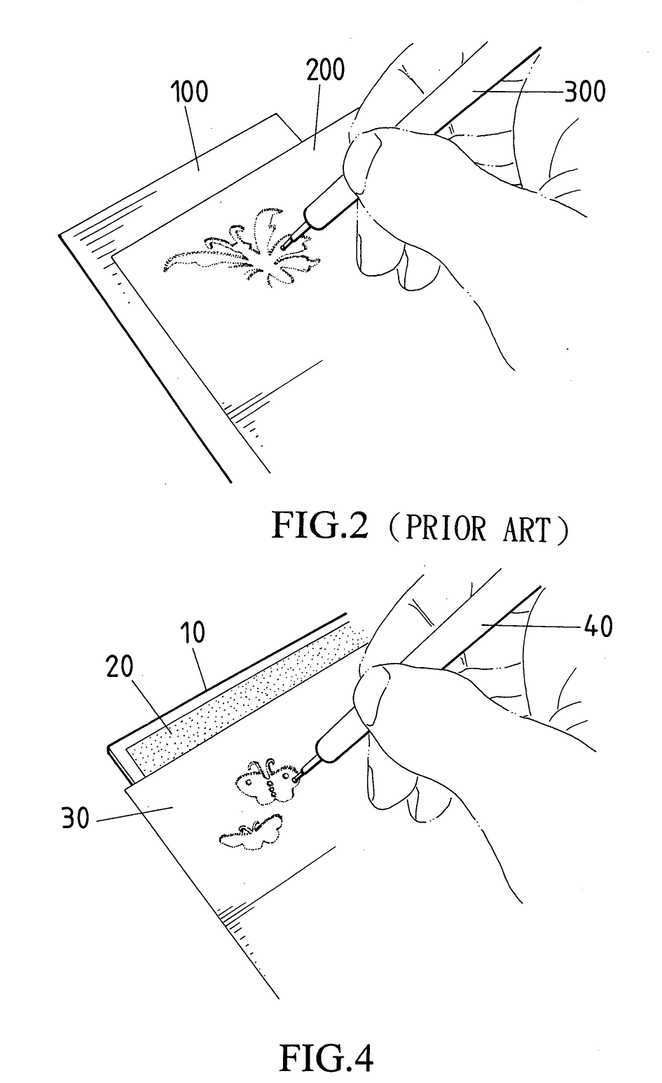

### DETAILED DESCRIPTION OF THE PREFERRED EMBODIMENTS

Referring to FIG. 3, the present invention is a transparent plastic relief board 10, on which is concaved with all kinds of shrinkage pools 11 of patterns or texts, and then projected parts on a surface of which are printed with a dark color 20, allowing the shrinkage pools 11 on the relief board 10 to be light permeable, but the projected color 20 to be light non-permeable.

Referring to FIG. 4, when a piece of relief paper 30 is put on the relief board 10, and is then put on a light box or a glass board of window, along with the relief board 10, all kinds of patterns or texts can be engraved on the paper 30 with a relief pen 40.

The plastic relief board 10 of the present invention is better than a conventional metallic relief board 100, and is provided with following advantages:
1. The plastic relief board 10 is not dug out with hollow holes, but is emplaced with the shrinkage pools 11. Therefore, when making patterns or texts, they can be mutually fitted convexly or concavely, without needing continuous figures. Hence, all kinds of patterns can be created.
2. The plastic relief board 10 is shaped easily, and manufactured conveniently.
3. Fingers will not be cut easily.

Accordingly, the present invention is a transparent plastic relief board, on which is concaved with all kinds of shrinkage pools, and projected parts on a surface of which are then printed with a color, allowing the shrinkage pools to be light permeable. Accordingly, a user can put a piece of relief paper or card on the relief board, and then use a relief pen to engrave into all kinds of embossed patterns on the shrinkage pools.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A do-it-yourself relief board, being a transparent relief board on which is concaved with shrinkage pools of all kinds of patterns or texts, projected parts on a surface of which are printed with a dark color, allowing the shrinkage pools to be light permeable; a piece of relief paper being put on the relief board and then on a light zone, and next all kinds of patterns being engraved on the paper with a relief pen.

2. The do-it-yourself relief board according to claim 1, wherein the relief board is a plastic product.
